(19) United States
(12) Patent Application Publication
(10) Pub. No.: US 2011/0020522 A1
(43) Pub. Date: Jan. 27, 2011

(54) PROCESS FOR PRODUCING GRANULAR LOW-CALORIE FOOD MATERIAL AND RAW MATERIAL FOR PRODUCING THE SAME

(76) Inventor: Mitsuo Emoto, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/866,494

(22) PCT Filed: Feb. 20, 2009
(86) PCT No.: PCT/JP2009/052949

§ 371 Date: Sep. 23, 2010

(30) Foreign Application Priority Data
Feb. 22, 2008 (JP) 2008-040955

(51) Int. Cl. A23L 1/0522

(52) U.S. Cl. 426/578

(57) ABSTRACT

A process for producing a granular low-calorie food material comprising the steps of forming a composition into granules, and drying the granules,

the composition comprising
(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.1 to 3 parts by mass of the divalent metal ion, and
(c-2) 0.1 to 15 parts by mass of a gelling agent capable of forming a gel upon heating or upon cooling after heating; and
(d) 1 to 25 parts by mass of an opacifying agent; and having a water content of 15 to 40% by mass.

### TECHNICAL FIELD

The present invention relates to a process for producing a granular low-calorie food material, and a raw material for producing the granular low-calorie food material. In particular, the present invention relates to a process and a raw material for producing a novel artificial rice having a low calorie content, a high dietary fiber content, and an advantage of becoming, when cooked with water, rice-like food having the same properties, appearance, smell, taste, and texture as those of boiled natural rice.

### BACKGROUND ART

Rice is the staple food of the Japanese. Since rice has a lot of starch and is relatively high in calories, control over consumption of rice is sometimes important for obese people or patients with lifestyle related disease triggered by obesity. Also, these days, people on a diet, mainly young women, need to significantly reduce their consumption of rice. Thus, the number of people who are not satisfied with a feeling of fullness after eating rice is increasing. Moreover, some patients with allergy or renal disease may need to reduce their consumption of rice.

Therefore, among these patients and others, it has been desired to develop artificial rice having the same texture and appearance as those of natural rice, having a lower calorie content than natural rice, and thus providing sufficient satisfaction that comes from eating natural rice.

As artificial rice, after the war enriched rice with vitamin B₁, which is insufficient in natural rice, was first made, but the rice was unpopular due to its color and the like. Also, the Staple Food Control Act produced undesirable stock of old rice stored for one or two years, and in order to improve the taste of the old rice, the surface thereof was treated with a gel. Furthermore, in the pursuit of convenience, instant rice and ready-to-eat rice were made. However, these rices had bad texture such as too smooth surfaces and lacked suitable firmness.

JP-A-2003-310187 discloses a low-calorie food material, which is gelled granules, and a process for producing the low-calorie food material. The low-calorie food material comprises (a) 1 part by weight of starch; (b) 0.05 to 2 parts by weight of trehalose; (c) at least one selected from the group consisting of (c-1) 0.03 to 7 parts by weight of a gelling agent capable of forming a gel in the presence of a divalent metal ion, and 0.003 to 0.5 parts by weight of the divalent metal ion, and (c-2) 0.03 to 7 parts by weight of a gelling agent capable of forming a gel upon heating or upon cooling after heating; and (d) 0.03 to 20 parts by weight of an opacifying agent. As with natural rice, this food material can be cooked by boiling or the like after the addition of a suitable amount of water if necessary, and can be served for human consumption. That is, the food material is artificial rice having the same taste, smell, and texture as those of boiled natural rice. However, when cooked by boiling or the like with water, the low-calorie food material easily loses its shape (the shape of granules) and fails to have the same appearance as that of natural rice. Therefore, in order to provide sufficient satisfaction that comes from eating natural rice, the low-calorie food material needs some means of keeping its shape even after cooked with water.

### SUMMARY OF INVENTION

### Technical Problem

It is an object of the present invention to provide a process and a raw material for producing a novel artificial rice that has advantages of hardly losing its shape even after water and heat are added, having the same taste, smell, texture, and appearance as those of boiled natural rice, and having a lower calorie contact than natural rice.

### Solution To Problem

In view of the current situation mentioned above, the inventors of the present invention conducted extensive investigations, and found that granules (a raw material for producing a granular low-calorie food material) that hardly lose their shapes even after water and heat are added can be obtained by the following steps: mixing the following ingredients of the raw material for producing the food material with water to give a composition (dough) having a water content of 15 to 40% by mass;

(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.1 to 3 parts by mass of the divalent metal ion, and
(c-2) 0.1 to 15 parts by mass of a gelling agent capable of forming a gel upon heating or upon cooling after heating; and
(d) 1 to 25 parts by mass of an opacifying agent;
and forming the composition into granules without gelation of the composition. The inventors also found that when the composition comprising the ingredients (a) to (d) and water has a water content of 15 to 40% by mass, it is easy to form the composition into granules and then to dry the granules. The inventors further found that, by drying such a raw material (granules) for producing a granular low-calorie food material, a dried product (a granular low-calorie food material) that is suitable for storage and distribution can be produced, and that the dried product hardly loses its shape and keeps its granular shape well even after heat and water are added.

Furthermore, the inventors found that a raw material (granules) for producing a granular low-calorie food material obtained by the production process mentioned above, or a granular low-calorie food material obtained by drying said raw material is suitable as artificial rice since the food material has , after water and heat are added thereto, the same taste, smell, and texture as those of natural rice and therefore can provide sufficient satisfaction that comes from eating natural rice, and has a lower calorie content and a higher dietary fiber content than natural rice. Thus, the present invention was completed.

That is, the present invention relates to (1) a process for producing a granular low-calorie food material comprising the steps of forming a composition into granules, and drying the granules,

the composition comprising
(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.1 to 3 parts by mass of the divalent metal ion, and
(c-2) 0.1 to 15 parts by mass of a gelling agent capable of forming a gel upon heating or upon cooling after heating; and
(d) 0.1 to 25 parts by mass of an opacifying agent; and having a water content of 15 to 40% by mass, and
(2) a raw material for producing a granular low-calorie food material comprising
(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.2 to 3 parts by mass of the divalent metal ion, and
(c-2) 0.1 to 15 parts by mass of a gelling agent capable of forming a gel upon heating or upon cooling after heating; and
(d) 0.1 to 25 parts by mass of an opacifying agent; and having a water content of 15 to 40% by mass.

The present invention further relates to

(3) a use of a composition as a raw material for producing a granular low-calorie food material,
the composition comprising
(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.2 to 3 parts by mass of the divalent metal ion, and
(c-2) 0.1 to 15 parts by mass of a gelling agent capable of forming a gel upon heating or upon cooling after heating; and
(d) 0.1 to 25 parts by mass of an opacifying agent; and having a water content of 15 to 40% by mass.

### Advantageous Effects of the Invention

The production process of the present invention is easy to carry out, and can produce a novel low-calorie food material that becomes, after water and heat are added, rice-like food having advantages of hardly losing its shape, and having the same appearance, properties, smell, taste, texture, and the like as those of boiled natural rice.

### BRIEF DESCRIPTION OF DRAWINGS

FIG. 1 is a front view of an extruder die suitable for producing a food material of the present invention.

FIG. 2 is a sectional side view of an extruder die suitable for producing a food material of the present invention.

FIG. 3 is a partial enlarged view of the die shown in FIG. 1.

FIG. 4 is a partial enlarged view of the die shown in FIG. 2.

### DESCRIPTION OF EMBODIMENTS

The present invention will be explained in detail below.

(a) Starch used in the present invention is not particularly limited, and any kind of starch, including natural starch and modified starch, both of which are conventionally used in food, can be used. Examples of the starch include natural starches such as rice starch, cornstarch, wheat starch, barley starch, waxy cornstarch, sweet potato starch, and potato starch; grain powder containing these starches; modified starches such as high amylose starch, cross-linked starch, substituted starch, thin boiling starch, starch acetate, hydroxyalkyl starch, and pregelatinized starch; and modified starch obtained by a combination of the modification treatments for producing these modified starches. These starches can be suitably used either alone or in combination. Preferable starch is a modified starch obtained by a chemical treatment such as esterification or etherification of a carboxyl group in starch, including cross-linked starch, substituted starch, thin boiling starch, starch acetate, and hydroxyalkyl starch. Among these, modified starches that have a peak value in the Brabender viscosity (measured with a Brabender viscometer) of 600 to 800 Bu are most preferable.

The amount of starch used in the production process of the present invention can be suitably selected depending on desired appearance, a desired shape, and desired properties of the rice-like food to be obtained by, for example, adding water and heat to the granular low-calorie food material (hereinafter, sometimes referred to as simply a food material) to be produced. Generally, the amount of starch (dry mass equivalent) used is preferably about 10 to 80% by mass, more preferably about 20 to 75% by mass, still more preferably about 30 to 70% by mass, of the total amount of a composition before being formed, the composition comprising starch, trehalose, a gelling agent, a divalent metal ion, and an opacifying agent.

(b) As trehalose (O-α-D-glucopyranosyl-(1,1)-α-D-glucopyranoside), a commercially available product, for example, a product produced by Wako Pure Chemical Industries, Ltd. can be used. Trehalose obtained by various kinds of known methods can also be used. Examples of the trehalose include trehalose produced by culturing a yeast belonging to the genus Filobasidium that is capable of producing trehalose, as described in JP-A-05-292986. Trehalose is a sugar having mildly sweet taste. Besides its αα-isomer, which mostly exists in the natural environment, its αβ-isomer and ββ-isomer are known. In the present invention, all these isomers can be used, and especially the αα-isomer can be used at a low cost.

Trehalose can exert an effect of providing a food material obtained by the production process of the present invention with the same quality as that of a grain of natural rice. That is, trehalose mixed in the food material can mask distinctive smell and taste originating from other ingredients, especially starch and a gelling agent; and thus trehalose can exert an effect of making the smell and taste of the obtained food material indistinguishable from those of natural rice.

Trehalose is suitably used in the range of 0.3 to 10 parts by mass, preferably in the range of about 0.3 to 6 parts by mass, more preferably in the range of about 1 to 5 parts by mass, relative to 50 parts by mass of starch. Trehalose in the range mentioned above can make the taste, smell, and the like of a food material obtained by the present invention indistinguishable from those of natural rice. When the amount of trehalose is much less than the range mentioned above, trehalose may not exert a sufficient effect of improving taste, smell, and the like of the food material produced by the present invention. Conversely, when the amount of trehalose is far beyond than the range mentioned above, the sweet taste of trehalose may be noticeable in the food material obtained by the present invention, and the taste of the food material may be different from that of natural rice.

(c) A gelling agent that is used in the present invention is (c-1) a gelling agent capable of forming a gel in the presence of a divalent metal ion, or (c-2) a gelling agent capable of forming a gel upon heating or upon cooling after heating. As such a gelling agent, any gelling agent that is used in the field of food industry can be used. The gelling agent (c-1) and the gelling agent (c-2) can be used either alone or in combination.

(c-1) Examples of the gelling agent capable of forming a gel in the presence of a divalent metal ion include pectic acid, alkaline salt of pectic acid, carrageenan, alginic acid, alkaline metal salt of alginic acid, low methoxy pectic acid, alkaline salt of low methoxy pectic acid, konjac refined powder, and konjac mannan. In these gelling agents, konjac refined powder, konjac mannan, and the like have a sufficient capability of forming a gel upon heating after the addition of a divalent metal ion.

(c-2) Examples of the gelling agent capable of forming a gel upon heating include egg white, gellan gum, and curdlan. Examples of the gelling agent capable of forming a gel upon cooling after heating include gelatin, casein, gum arabic, guar gum, locust bean gum, and agar.

As a gelling agent in the present invention, it is especially preferable to use a combination of (1) at least one selected from the group consisting of konjac refined powder and konjac mannan; and (2) at least one selected from the group consisting of a gelling agent capable of forming a gel in the presence of a divalent metal ion, not including the above-mentioned konjac refined powder and konjac mannan, and the above-mentioned gelling agent capable of forming a gel upon heating or upon cooling after heating. As the gelling agent capable of forming a gel in the presence of a divalent metal ion, not including konjac refined powder and konjac mannan, carrageenan is preferable. In this context, the used amount of at least one selected from the group consisting of konjac refined powder and konjac mannan varies depending on the kind of other gelling agents and the like and cannot be generalized, but usually the amount is preferably 30% by mass or more, more preferably about 50% by mass of the total amount of all the gelling agent, which is 100% by mass.

A gelling agent is used in the range of 0.1 to 15 parts by mass, preferably in the range of 0.1 to 10 parts by mass, more preferably in the range of about 0.2 to 7 parts by mass, still more preferably in the range of about 0.3 to 6 parts by mass, relative to 50 parts by mass of starch. When konjac mannan, which is one of especially preferable gelling agents, is used, the amount of konjac mannan is chosen from the range of 0.1 to 10 parts by mass, preferably from the range of about 0.2 to 7 parts by mass, still more preferably from the range of 0.3 to 6 parts by mass, relative to 50 parts by mass of starch. A gelling agent in these ranges can make the texture of a food material obtained by the present invention similar to that of natural rice. When the amount of a gelling agent in the obtained food material is far beyond the upper limit of the range mentioned above, the food material with the addition of water and heat may become a gel having higher elasticity than that of boiled natural rice. Conversely, when the amount of a gelling agent in the obtained food material is much less than the lower limit of the range mentioned above, the food material with the addition of water and heat may become a gel having insufficient elasticity and may not have the same texture as that of boiled natural rice.

When (c-1) a gelling agent capable of forming a gel in the presence of a divalent metal ion is used as a gelling agent, a low-calorie food material obtained by the production process of the present invention further contains the divalent metal ion or a divalent metal salt containing the divalent metal ion. The divalent metal ion or the divalent metal salt may be of any kind as long as it is safe for human consumption and works together with the gelling agent to form a gel. Examples of such a divalent metal ion or divalent metal salt include a divalent metal ion such as calcium and magnesium, and a compound containing said divalent metal ion. Examples of the compound include a water-soluble divalent metal salt, for example, a calcium salt such as calcium chloride, calcium lactate, calcinated egg shell calcium, and calcinated oyster shell calcium; and a water-soluble magnesium salt such as magnesium chloride, and magnesium lactate. These divalent metal salts exemplified are preferable in view of taste. The divalent metal ion or the compound containing the divalent ion mentioned above can be used either alone or in combination. The amount of the divalent metal ion that is used is suitably chosen from the range of 0.1 to 3 parts by mass, preferably from the range of about 0.1 to 2 parts by mass, more preferably from the range of about 0.1 to 1 part by mass, relative to 50 parts by mass of starch. The divalent metal ion in these ranges can sufficiently work together with the gelling agent mentioned above to form a gel. More specifically, the amount of the divalent metal ion in the range mentioned above is converted into the amount of the divalent metal ion salt, and then the converted amount of the divalent metal ion salt is mixed in a food material. The divalent metal salt mentioned above in a food material may be in the form of a divalent metal salt or a divalent metal ion.

(d) An opacifying agent is added for the purpose of providing the same turbid appearance as that of natural rice and of adding dietary fiber. The opacifying agent is preferably a refined powder obtained by a chemical or physical method. Suitable examples of the opacifying agent include powdered cellulose having an average degree of polymerization of 100 to 300 and a size passing about 60 mesh screen, and a powdered cellulose having a polymerization degree of 100 or less (see JP-A-57-212231, JP-A-59-219333, JP-A-61-211342, JP-A-62-138538, JP-A-62-240302, JP-A-03-152130, JP-A-03-163135, JP-B-60-19921, JP-B-62-30220, JP-B-63-44763, JP-B-02-12491, and the like). The suitable powdered cellulose that is used can exert effects of , besides providing turbid appearance as mentioned above and adding dietary fiber, improving a water retaining property of a food material obtained by the present invention, and preventing the separation of added water from granules of the food material for a long period of time; and thus, the suitable powdered cellulose can exert an effect of adjusting the texture and mouth feeling during chewing of the food material to those of boiled natural rice.

Besides the celluloses mentioned above, examples of the opacifying agent include bone powder, silk, talc, and kaolin.

The amount of the opacifying agent that is used is suitably chosen from the range of 1 to 25 parts by mass, preferably from the range of about 3 to 20 parts by mass, more preferably from the range of about 5 to 15 parts by mass, relative to 50 parts by mass of starch.

When modified starch is used as starch, konjac refined powder and/or konjac mannan is used as a gelling agent, and the suitable powdered cellulose mentioned above is used as an opacifying agent, the amount of the powdered cellulose as an opacifying agent that is used is preferably in the range mentioned above relative to the amount of starch, and at the same time the amount of the powdered cellulose is the same as or more than the total mass of konjac refined powder and konjac mannan. The amount of the powdered cellulose is preferably about 1.5 times by mass of the total mass of konjac refined powder and konjac mannan.

In the production process of the present invention, besides the above-mentioned essential ingredients (a) to (d) for a raw material of a food material, various kinds of edible materials that are conventionally known to be used for foods or drinks can be suitably added to and mixed in the food material if necessary as long as the edible materials do not produce any adverse effect on the appearance, texture, taste, or the like of the food material. Examples of such an edible material include vitamins, minerals, a fragrance, a thickener, a colorant, a flavor, and dietary fiber. In addition, various kinds of protein, peptide, fat, and a condiment (sugar, salt, soy sauce, and the like) that are well known as an edible material can be suitably added and mixed if necessary.

In the production process of the present invention, a predetermined amount of each of the ingredients (a) to (d) mentioned above, and other ingredients that are mixed if necessary, are first mixed, agitated, and kneaded with a suitable amount of water to prepare a semisolid composition (dough). This mixing, agitating, and kneading can be carried out with the use of a suitable mixing and kneading means such as a rotary pan, a mixer, and the like according to a conventional method.

In the present invention, the amount of water added to a composition comprising a predetermined amount of each of the ingredients (a) to (d) mentioned above, other ingredients added if necessary, and water, is adjusted so that a water content of the composition is 15 to 40% by mass. This water content is based on 100% by mass of the total composition. When the water content of the composition is over 40% by mass, and (c-1) a gelling agent capable of forming a gel in the presence of a divalent metal ion is used as a gelling agent with the divalent metal ion, there are cases where the gelling agent and the divalent metal react and form a gel in the composition. When this gelled composition was formed and dried to give a food material, the food material with the addition of water and heat will easily lose its shape and fail to have the same appearance as that of boiled natural rice. Also, when the water content of the composition is over 40% by mass, the viscosity of the composition is small; therefore, there are cases where the composition is difficult to form into granules, or where the formed granules stick together before dried and a granular food material cannot be obtained. Furthermore, the efficiency of drying the obtained granules reduces. Conversely, when the water content is under 15% by mass, there are cases where an extruder does not work properly to form the composition into granules. Furthermore, there are cases where the composition foams. The water content mentioned above is preferably about 15 to 40% by mass, more preferably about 20 to 35% by mass, especially preferably about 23 to 28% by mass, most preferably about 25 to 27% by mass, based on 100% by mass of the total composition.

The order of mixing water and each of the ingredients mentioned above is not particularly limited, and includes (1) a process comprising the steps of premixing a predetermined amount of each of the ingredients mentioned above, adding a suitable amount of water to the mixture, and mixing the mixture; and (2) a process comprising the steps of adding the predetermined amount of each of the ingredients mentioned above to a suitable amount of water, and mixing the mixture. The process (1) is preferable.

The thus obtained composition is fed into a suitable extrusion machine, extruded at any given speed, and cut in the vicinity of a discharge opening of a die of the extrusion machine to give granules (pellets). As the extrusion machine, any of various kinds of extrusion machines can be used, and a usual extruder and the like can also be used. The usual extruder is convenient especially because the production of the composition (dough) can be done in one step.

When the composition (dough) mentioned above is prepared and formed, the temperature is preferably about 40 to 100° C., more preferably about 50 to 90° C., still more preferably about 60 to 85° C. The pressure during extrusion is preferably about 1 to 20 MPa, more preferably about 1 to 10 MPa, still more preferably about 1 to 8 MPa. These ranges of the temperature and pressure are preferable because a product (a raw material for producing a granular low-calorie food material and the food material) obtained in such conditions has especially good quality (texture and the like).

In the present invention, especially by suitably selecting a shape of a die or a nozzle of the extruder mentioned above, a food material obtained by the present invention can be formed into a desired size and shape. Granules obtained by forming the composition mentioned above is preferably in a shape that becomes similar to a grain of boiled natural rice when the granules or a food material obtained by drying the granules are heated with water, and the granules are preferably formed into the shape of a rice grain. In addition, preferable examples of the shape include an oval shape, a pellet shape, the shape of rolled barley, and a sphere shape. The size of the granules is, for example, preferably about 2 to 5 mm in diameter and about 5 to 15 mm in length.

For example, a die in a shape as shown in attached drawings can be used.

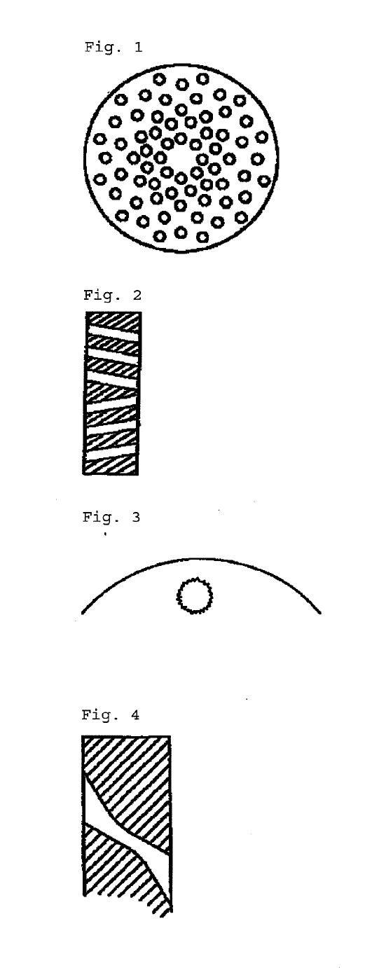

FIG. 1 is a front view of a die used in the production process of the present invention. FIG. 2 is a sectional side view of the die. FIG. 3 is a partial enlarged view of FIG. 1. FIG. 4 is a partial enlarged view of FIG. 2.

A preferable die is a nozzle tapered in the middle as shown in FIG. 4. When a composition is extruded through the nozzle tapered in the middle, the nozzle creates pulsating pressure, which gives pellets having an undulated shape in the longitudinal direction. In addition, by forming the opening of the nozzle into not a perfect circle but a wavy circle (see FIG. 3), the surface of the pellets can be provided with shallow, narrow cuts in the longitudinal direction. Thus, the appearance of the pellets can be similar to that of rice grains. Furthermore, by slightly inclining the nozzle opening upwardly or downwardly away from the extrusion direction, the extruded composition can be cut into cylindrical pellets whose surfaces in the longitudinal direction look like a rhombus (see FIG. 2 and FIG. 4). Thus, the appearance of the pellets can be more similar to that of rice grains.

Granules obtained by the process mentioned above are a raw material for producing a granular low-calorie food material, comprising

(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.1 to 3 parts by mass of the divalent metal ion, and
(c-2) 0.1 to 15 parts by mass of a gelling agent capable of forming a gel upon heating or upon cooling after heating; and
(d) 1 to 25 parts by mass of an opacifying agent; and having a water content of 15 to 40% by mass.
This raw material for producing a granular low-calorie food material to be gelled is also a part of the present invention.

Furthermore, the raw material (granules) for producing a granular low-calorie food material to be gelled can be dried and used as a dried (having a low water content) food material. A method of drying the raw material is not particularly limited, and a known method such as hot air drying, hot air fluidized-bed drying, and vacuum drying can be used. The drying is carried out usually until the water content of the granules becomes preferably 25% by mass or less, more preferably 15% by mass or less, still more preferably 10% by mass or more. By this drying process, a granular low-calorie food material can be obtained. The drying temperature is preferably about 50 to 200° C., more preferably about 70 to 150° C. The drying time is preferably about 10 to 120 minutes, more preferably about 20 to 60 minutes.

In cases where a gelling agent capable of forming a gel in the presence of a divalent metal ion is used in the production process of the present invention, the following steps may be used: mixing or the like a predetermined amount of each of the ingredients mentioned above (except a divalent metal salt) with water to prepare a composition; extruding the composition into granules with the use of an extruder; drying the granules; and applying an aqueous solution of a compound comprising a divalent metal ion on the dried granules (by, for example, spraying, dispersing, immersing, or the like). When the aqueous solution of a compound comprising a divalent metal ion is sprayed or the like, for example, it is preferable that an aqueous solution having a concentration of a divalent metal ion of about 1 to 30% by mass be sprayed onto the dried granules and the amount of the sprayed solution be about 1 to 5% by mass of the total mass of the dried granules. The granules whose surfaces are applied with the divalent metal ion by spraying or the like can also be dried to give a granular low-calorie food material.

A raw material for producing a granular low-calorie food material and a granular low-calorie food material produced by the production process of the present invention are to be gelled to have the same texture as that of natural rice. As a process of gelling the material, when a gelling agent capable of forming a gel in the presence of a divalent metal ion is used in the granular low-calorie food material, contact between the gelling agent and the divalent metal ion triggers the reaction to form a gel. When a gelling agent capable of forming a gel upon heating or upon cooling after heating is used in the granular low-calorie food material, a gel can be formed by heating the food material to or above a temperature that is necessary for the gelling agent to form a gel, or by heating the food material to dissolve the gelling agent and then cooling (releasing the heat from) the food material. The heating can be carried out with the use of a suitable heating means such as a means with the use of warm water, hot water, steam, hot air, or the like.

A raw material for producing a granular low-calorie food material or a granular low-calorie food material produced by the production process of the present invention, as with natural rice, can be cooked by boiling or the like after the addition of a suitable amount of water if necessary, and can be served as boiled rice for human consumption. The raw material for producing a granular low-calorie food material or the granular low-calorie food material can be blended with natural rice. The ratio of blending natural rice and the raw material for producing a granular low-calorie food material or the granular low-calorie food material when cooked and eaten as boiled rice is not limited to a particular ratio. The raw material for producing a granular low-calorie food material or the granular low-calorie food material is cooked by boiling or the like after water is added as mentioned above, and is eaten as boiled rice. The amount of water added to the raw material for producing a granular low-calorie food material or the granular low-calorie food material is suitably determined according to the water content of the material, and is not limited to a particular amount. Generally, the suitable amount of the water is about 0.4 to 6 times the mass of the granular low-calorie food material (dry mass basis). For example, when only the granular low-calorie food material is heated with water, the amount of the water is preferably about 2.5 to 3 times the mass of the granular low-calorie food material. The boiling can be carried out according to a conventional method, and the boiling time is, for example, 20 to 40 minutes. The granular low-calorie food material obtained by the production process of the present invention can also be developed into a marketed product by being packed in a suitable container such as a can that can be sterilized by heating, a heat-resistant plastic container, and a retort pouch, and then sterilized by heating according to a conventional method.

Rice-like food obtained with the use of a raw material for producing a granular low-calorie food material or a granular low-calorie food material produced by the production process of the present invention has excellent quality in appearance, texture, and the like that cannot be substantially differentiated from those of natural rice, and the rice-like food can be a substitute as artificial rice for natural rice. Therefore, the rice-like food can be used effectively in the field of food industry in various applications such as boiled rice, boiled rice with tea poured over it, a rice ball, and sushi. Of course, the rice-like food can be blended with natural rice as mentioned above, and then also be used in various applications.

A part of the present invention is a use of a composition as a raw material for producing a granular low-calorie food material,

the composition comprising
(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.2 to 3 parts by mass of the divalent metal ion, and
(c-2) 0.1 to 15 parts by mass of a gelling agent capable of forming a gel upon heating or upon cooling after heating; and
(d) 0.1 to 25 parts by mass of an opacifying agent; and having a water content of 15 to 40% by mass.

A preferable embodiment of the composition in the present invention is the same as that of the composition used for producing the above-mentioned raw material for producing a granular low-calorie food material. A raw material for producing a granular low-calorie food material produced from such a composition is suitable as a raw material of the above-mentioned granular low-calorie food material.

### EXAMPLES

The present invention will be described more specifically with the reference to the following Examples and Test Examples, but the present invention is not limited thereto. In the following Examples, unless otherwise noted, “parts” means “parts by mass” and “%” means “% by mass. ”

### Example 1

The predetermined amounts (parts, figures below show a mass ratio relative to the mass ratio of the starch) of the following ingredients were homogeneously mixed with the use of a mixer (manufactured by Sanei Seisakusho Co. Ltd., product name: 20 DMW) to give powder mixture.

1. starch 50 parts;
2. cellulose 10 parts;
3. konjac refined powder 3 parts;
4. trehalose 3 parts;
5. calcium hydroxide 2 parts

The powder mixture, which was homogeneously mixed (having a water content of about 5%: a water content contained in the ingredients), was fed into a screw extruder (manufactured by FMI, PX30) having a hole 1 to 4 mm in diameter at the outlet. Next, a predetermined amount of water was fed into the screw extruder. The powder mixture and the water were mixed and kneaded, and at the same time extruded into a cylindrical-shape paste at a temperature of 70° C. and under a pressure of 3. Meanwhile, the extruded paste was cut into pellets about 5 mm in length.

The amount of the water mixed in the powder mixture was about 20% of the sum total of the mass of the powder mixture and the water. That is, the amount of the water mixed in the powder mixture was adjusted so that the water content of the mixture of the powder mixture and the water was 24 to 26%. The mixture of the powder mixture and the water was easily formed into pellets.

Next, the obtained white granules were dried at 105° C. for 60 minutes with a hot air dryer having a conveyor belt to give a granular food material (average diameter 1 mm×length 4 mm) (in dry form) having a water content of about 10%.

### Test Example 1

The amount of 5 parts of water, 1 part of the food material in dry form obtained in Example 1, and 1 part of polished natural rice were put into an electric rice cooker, and boiled for about 20 minutes to give boiled rice sample.

Sensory evaluation by ten assessors (aged 23 to 47 years, consisting of six men and four women) having sensory perception was carried out on the smell, taste, and texture of the obtained boiled rice sample just after the rice was boiled, and after the boiled rice was left at a temperature of 16° C. for one hour. The appearance of the obtained boiled rice sample was not much different from that of boiled natural rice with visual evaluation.

The smell, taste, and texture as boiled rice were evaluated using five grades: “preferable,” “rather preferable,” “normal,” “rather inferior,” and “inferior.” The obtained results (the number of assessors who gave each grade) are shown in Table 1 below.

TABLE 1

| | | Sensory evaluation | | | | |
|---|---|---|---|---|---|---|
| | | | Rather | | Rather | |
| | | Preferable | preferable | normal | inferior | Inferior |
| just | smell | 1 | 1 | 7 | 1 | 0 |
| after | taste | 0 | 1 | 8 | 1 | 0 |
| boiling | texture | 0 | 0 | 7 | 3 | 0 |
| 1 hour | smell | 0 | 1 | 8 | 1 | 0 |
| after | taste | 0 | 0 | 7 | 3 | 0 |
| boiling | texture | 0 | 0 | 8 | 2 | 0 |

It is obvious from the results shown in Table 1 that the boiled rice containing the granular low-calorie food material produced by the production process of the present invention had the same good taste, smell, and texture as those of boiled natural rice.

### Example 2

Ingredients were mixed and extruded to give pellets in the same manner as in Example 1 except that the water content was about 35% of the sum total of the mass of the powder mixture and the water. The water content of the mixture of the powder mixture and the water was 39 to 40%. The mixture of the powder mixture and the water was easily formed into pellets.

Next , the obtained white granules were dried under the same condition as in Example 1 to give a granular food material (average diameter 1 mm×length 4 mm) (in dry form) having a water content of about 10%.

### Test Example 2

The amount of 1 part of the food material in dry form obtained in Example 2 and 1 part of polished natural rice were added to 5 parts of water, and boiled (at 100° C. for 20 minutes) to give boiled rice sample. The appearance of the obtained boiled rice sample was not much different from that of boiled natural rice with visual evaluation.

The boiled rice sample obtained from this food material was evaluated through a panel test according to the evaluation method described in Test Example 1, and the results were the same as those of the food material produced in Example 1.

### Example 3

Ingredients were mixed and extruded to give pellets in the same manner as in Example 1 except that the water content was about 10% of the sum total of the mass of the powder mixture and the water. The water content of the mixture of the powder mixture and the water was 15%.

The mixture of the powder mixture and the water was easily formed into pellets.

Next , the obtained white granules were dried under the same condition as in Example 1 to give a granular food material (average diameter 1 mm×length 4 mm) (in dry form) having a water content of about 10%.

### Test Example 3

The amount of 1 part of the food material in dry form obtained in Example 3 and 1 part of polished natural rice were added to 5 parts of water, and boiled (at 100° C. for 20 minutes) to give boiled rice sample. The appearance of the obtained boiled rice sample was not much different from that of boiled natural rice with visual evaluation.

The boiled rice sample was evaluated through a panel test according to the evaluation method described in Test Example 1, and the evaluation was that the boiled rice sample was able to give rice-like food having the same excellent smell, taste, and texture as those of the food material obtained in Example 1.

### Comparative Example 1

Ingredients were mixed and extruded to give pellets in the same manner as in Example 1 except that the water content was about 43% of the sum total of the mass of the powder mixture and the water. However, since the mixture had a large water content, it was difficult to form the mixture into pellets. That is, the extruded paste was cut into pellets about 5 mm in length, but the obtained pellets stuck together.

Next, the obtained white granules were dried at 105° C. for 60 minutes with a hot air dryer having a conveyor belt to give a granular food material (average diameter 1 mm×length 4 mm) (in dry form) having a water content of about 10%.

### Test Example 4

The amount of 1 part of the food material in dry form obtained in Comparative Example 1 and 1 part of polished natural rice were added to 5 parts of water, and boiled (at 100° C. for 20 minutes) to give boiled rice sample. The obtained boiled rice sample was difficult to form into pellets, and the appearance was not similar to that of rice with visual evaluation. That is, the boiled rice sample dissolved and lacked a solid shape.

The boiled rice sample was like mushy rice porridge, whose taste was not able to be evaluated.

### Comparative Example 2

Ingredients were mixed and extruded to give pellets in the same manner as in Example 1 except that the water content was about 8% of the sum total of the mass of the powder mixture and the water. However, since the mixture had a small water content, the extruder did not work properly and the mixture foamed. As a result, pellets were not able to be produced.

### INDUSTRIAL APPLICABILITY

The production process of the present invention is advantageous, because the production process is easy to carry out, and can produce a novel low-calorie food material used as rice-like food that has advantages of hardly losing its shape even after water and heat are added. and having the same appearance, properties, smell, taste, texture, and the like as those of boiled natural rice.

1. A process for producing a granular low-calorie food material comprising the steps of forming a composition into granules, and drying the granules,
the composition comprising
(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.1 to 3 parts by mass of the divalent metal ion, and
(c-2) 0.1 to 15 parts by mass of a gelling agent capable of forming a gel upon heating or upon cooling after heating; and
(d) 1 to 25 parts by mass of an opacifying agent; and
having a water content of 15 to 40% by mass.

2. A raw material for producing a granular low-calorie food material comprising
(a) 50 parts by mass of starch;
(b) 0.3 to 10 parts by mass of trehalose;
(c) at least one selected from the group consisting of
(c-1) 0.1 to 15 parts by mass of a gelling agent capable of forming a gel in the presence of a divalent metal ion, and 0.1 to 3 parts by mass of the divalent metal ion, and
(c-2) 0.1 to 15 parts by mass of a gelling agent capable of forming a gel upon heating or upon cooling after heating; and
(d) 1 to 25 parts by mass of an opacifying agent; and
having a water content of 15 to 40% by mass.
